(19) United States
(12) Patent Application Publication
(10) Pub. No.: US 2005/0140487 A1
(43) Pub. Date: Jun. 30, 2005

(54) Inductive components

(75) Inventors: Mika Matti Sippola, Helsinki (FI); Kevin McGrane, Bury St. Edmunds (GB)

Correspondence Address: BURR & BROWN, PO BOX 7068, SYRACUSE, NY, 13261-7068, US

(73) Assignee: PROFEC TECHNOLOGIES OY, Nummela (FI)

(21) Appl. No.: 10/988,068

(22) Filed: Nov. 12, 2004

Related U.S. Application Data
(63) Continuation of application No. 10/415,854, filed on Oct. 22, 2003, now abandoned.

(30) Foreign Application Priority Data
Nov. 4, 2000 (GB) 0027007.4

(51) Int. Cl. H01F 5/00

(52) U.S. Cl. 336/200

(57) ABSTRACT

An inductive component, such as a transformer, is made by applying conductive tracks onto a thin, foldable substrate (10) and then Z-folding the substrate so that the conductive tracks from a coil. A ferrite core is then placed through the coil. In order to maximise the current capacity of the transformer, there are electrical connections between leaves not only around each fold line (14) where the track traverses the fold line, but also between specially prepared areas X-X of the tracks which end up facing each other from adjacent folds once the substrate has been folded.

This invention relates to inductive and inductive-capacitative components, such as transformers, inductors and LC-resonators, to principles of construction of such components, and to methods of making such components.

Transformers serve to transfer an electrical current from one circuit to another, (through an electrical induction effect between adjacent current carrying coils. Transformers can carry large currents, in which case they are often referred to as power transformers, or small currents intended to transmit signals rather than power, and such transformers are referred to as signal transformers. The present invention is concerned with all types of transformers and any other inductive components such as inductors, electromagnetic interference chokes or coreless inductive components.

Conventional transformer construction requires the winding of coils of wire and placing these coils adjacent one another with appropriate insulation and isolation between the respective coils.

It is also possible to produce windings by a printed method using multi-layer printed circuit boards (PCB). With a multi-layer PCB one needs to connect layers together using vias. The number of layers that can be incorporated into a PCB is around 12, as it would be prohibitively expensive to add more layers than this.

Recently it ha been proposed to form the coils by printing serpentine conductive tracks onto a flexible, foldable substrate and then folding the substrate backwards and forwards onto itself so that the individual folds form a stack. The stack is then assembled with ferrite cores (which generally pass through preformed holes in the substrate) to form a transformer. Such transformers are known as Z-folded transformers.

Examples of Z-fold transformers are described in U.S. Pat. No. 4,959,630. Such transformers are manufactured from a flat, foldable substrate of insulating material on which serpentine conductive tracks are printed. After printing these tracks, the substrate (referred to as a flex strip) is folded about predetermined fold lines, so that sequential parts of primary and secondary conductive cracks overlie one another to form a stack of interleaved primary and secondary windings.

An advantage of Z-folded transformers over conventional wound wire transformers is that they are easy to manufacture and take up relatively little space and can be designed to have a low profile. Another advantage is that those transformers can have very high efficiency (low losses) at high frequency.

An advantage of Z-folded transformers over conventional layered PCB transformers is that the Z-fold system is not limited in its layers and can have buried vias to produce connections between tracks on different leaves. Connections between leaves can be made around the folds.

A disadvantage of known Z-folding techniques is that the area of the conductive layer on the substrate which actually conducts electricity is limited, and this limits the performance of the transformer. Other problems relate to the completion of the transformer as a stable, rigid package which is required to enable the transformer to be mounted with other components on a circuit board, and the presentation of the transformer terminals in a position where it is easy to make electrical connections to a circuit board or to other electrical components.

According to a first aspect of the invention, there is provided an inductive component comprising an insulating substrate with conductive tracks laid down on the substrate and covered by a layer of insulation, wherein the substrate is folded into a plurality of connected, overlapping leaves and is combined with a ferrite core to form the inductive component, and wherein parts of the tracks have conductive surfaces exposed through the insulation, which parts of the track are in electrical contact with other exposed conductive surfaces on adjacent leaves.

The invention also provides a flexible, foldable insulating substrate which has conductive tracks laid down on the substrate, holes through the substrate for accepting a ferrite core, and wherein parts of the tracks have exposed conductive surfaces which, when the substrate is folded into a plurality of connected, overlapping leaves, are in electrical contact with other exposed surfaces on adjacent leaves.

By allowing facing conductive surfaces to make contact between one layer and another, at selected positions, a much greater area of the conductive layer can participate in the conduction of current, leading to higher electromagnetic performance.

The substrate (flex strip) preferably used for Z-folded transformers is known as Kapton which is a flexible electrical insulating polymide film. (KAPTON is a registered trademark of E. I. Du Pont de Nemours and Company). The film is supplied precoated with a layer of conductive copper on both sides, To form the desired conductive tracks in the desired pattern, a resist is applied in an appropriate pattern to the copper surfaces to protect that part of the copper which will take part in the conduction of electricity. The unprotected part of the copper is then removed using known techniques, to leave the resist protected copper which follows a serpentine path across the substrate. Holes will be made through the substrate which line up with each other when the substrate is folded, to accept ferrite cores. The substrate is then folded on itself and combined with ferrite cores to form the transformer. To prevent there being electrical contact between tracks on surfaces which are in contact with one another after this folding, either the resist is left on the copper (if the resist is non-conductive), and/or the tracks are coated with an insulating lacquer of the like or insulator tape attached or laminated on the top of copper.

There are however many other methods for producing conductive tracks on a substrate. For example conductive tracks can be stamped out from sheets of conductive material and applied to tape which is then laminated onto a substrate; or printing the substrate in areas which a track is to be placed, and then electroplating a conductive layer on to the printed area.

The electrically conductive connection between tracks on adjacent leaves can connect the tracks on the leaves either in series or in parallel. Each track may extend across only one leaf, across a pair of adjacent leaves, or across all the leaves of a flex strip. The connections between adjacent leaves can be located anywhere on the leaves, and/or at their edges. There may be more than one connection between any particular pair of adjacent leaves.

According to a second aspect of the invention, there is provided a substrate for use as part of a Z-folded transformer, the substrate comprising a base web of a non-conductive plastics material; a layer of copper on at lease on face of the base web, and strips of a different plastics material along both longitudinal edges of the base web, the different plastic having a higher melting point than the material of the base web.

The invention also provides a method of preparing a flex strip for use in manufacturing a Z-folded transformer, the method comprising cutting the strip form a substrate as set forth above by cutting the substrate transverse to its length, to separate from the substrate a strip having a dimension which is greater in the direction transverse to the web than in the direction of the length of the web.

Preferably the base web is of polyester. Preferably the longitudinal edge strips are of polyimide.

The invention also provides a flex strip for use in manufacturing a Z-folded transformer, the strip having an elongate web of a first plastics material and, at the ends of the web, portions of a different plastics material which has a higher melting point that then material of the elongate web.

According to a third aspect of the invention, there is provided a transformer assembly comprising a Z-folded flex strip and a ferrite core, wherein the Z-folded strip is mounted between two ferrite bodies, and the ferrite bodies are clipped together to secure the Z-folded strip between the bodies.

The ferrite bodies may be clipped together by a C- or U-shaped clip which engages around both bodies, or the assembly of ferrite bodies and flex strip can be clipped into a housing which holds the components in the correct relative positions.

Preferably terminal ends of the flex strip wrap around the ferrite bodies and are held against a surface of one or other of the bodies by the clip or by the housing.

According to a fourth aspect of the invention, there is provided a Z-folded transformer comprising an insulating substrate with conductive tracks laid down on the substrate end covered by a layer of insulation, wherein the substrate is folded into a plurality of connected, overlapping leaves and is combined with a ferrite core to form a transformer, and wherein parts of the tracks have conductive surfaces exposed through the insulation, which parts of the track are in electrical contact with other exposed conductive surfaces on adjacent leaves.

According to a fifth aspect of the invention, there is provided a Z-folded transformer wherein a insulating substrate has a plurality of separate conductive tracks laid down on the substrate, the substrate is folded into a plurality of connected, overlapping leaves with leaves carrying one conductive track interleaved with leaves carrying another conductive track, the substrate being combined with a ferrite core to form a transformer.

The invention will now be further described, by way of example, with reference to the accompanying drawings, in which:

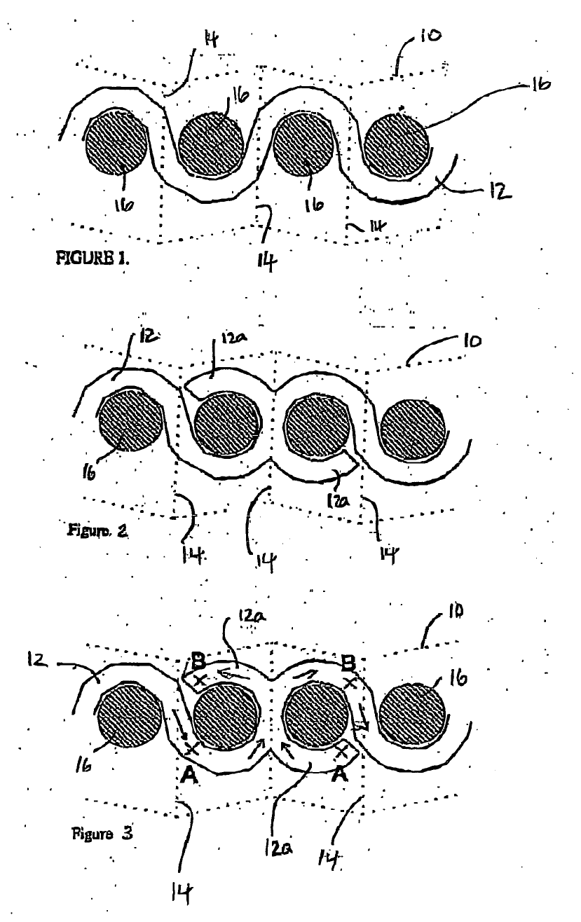

FIG. 1 shows a substrate with a conductive track thereon, ready for folding to form a transformer in accordance with the prior art.

FIG. 2 is a view similar to FIG. 1, but showing a substrate in accordance with the invention;

FIG. 3 shows the substrate of FIG. 2, with annotations;

FIG. 4 is a schematic cross-section through part of a transformer formed in accordance with the invention;

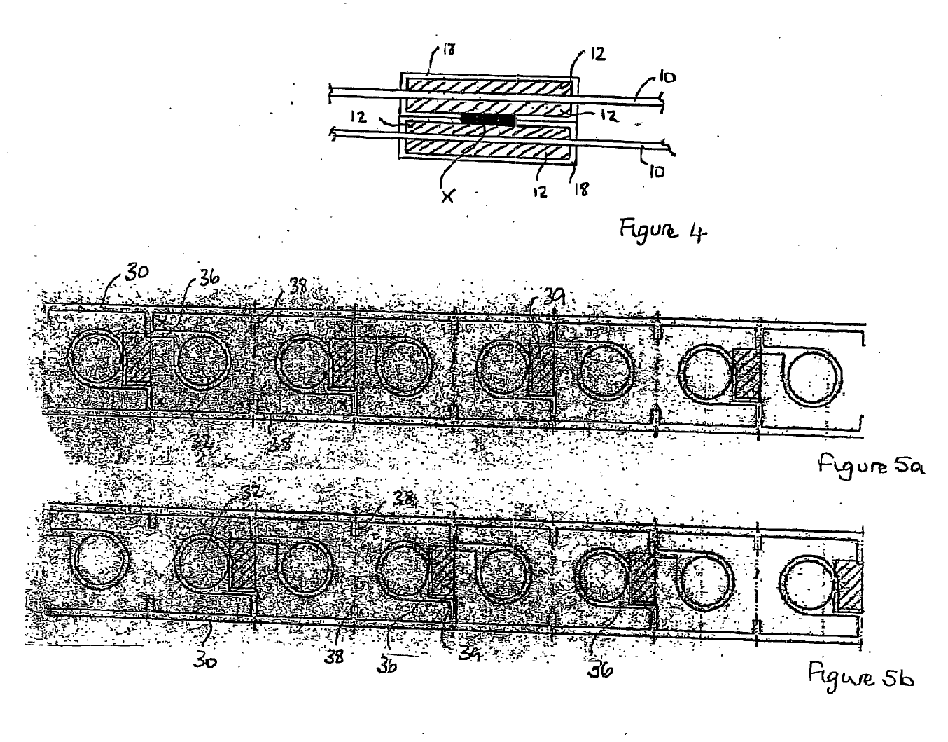

FIGS. 5a and 5b show opposite sides of a second embodiment of a substrate in accordance with the invention;

FIG. 6 shows part of a third embodiment of substrate in accordance with the invention;

FIG. 7 shows the embodiment of FIG. 6, partly folded to form a transformer,

FIGS. 8 to 12 show further embodiments of substrates in accordance with the invention;

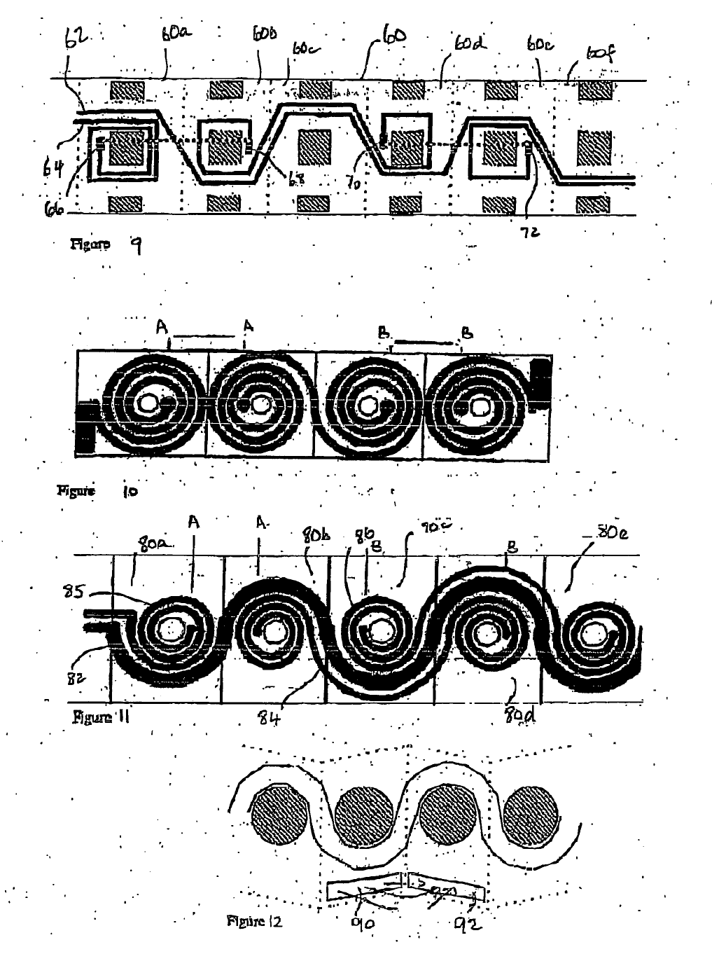

FIG. 13 illustrates a scheme for manufacturing a substrate web;

FIG. 14 shows a cross-section through a web manufactured in accordance with FIG. 13;

FIG. 15 is a plan view of the web of FIG. 14, showing how strips will be cut from the web;

FIG. 16 is a side view of a transformer in accordance with the invention;

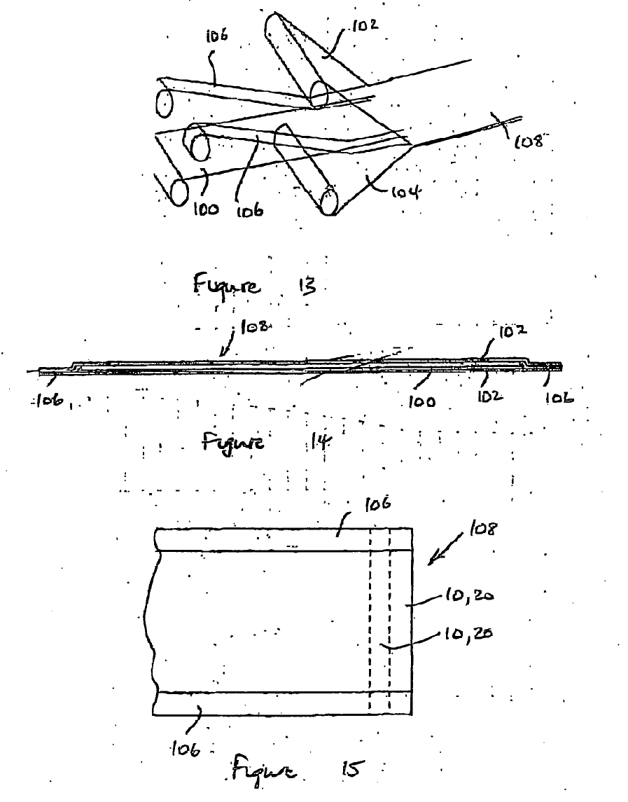

FIG. 17 is a side view similar to FIG, 16 of an another transformer in accordance with the invention;

FIG. 18 is an end view on the transformer of FIG. 17;

FIG. 19 shows a housing for containing a transformer;

FIG. 20 is a cross-section through a transformer housed in the housing of FIG. 19;

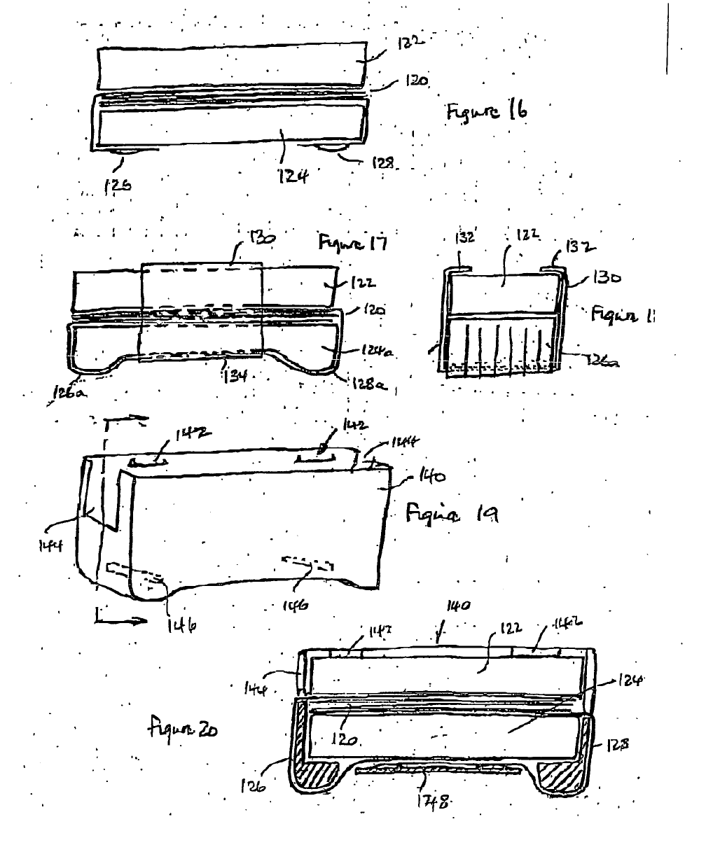

FIGS. 21 and 22 show alternative constructions in which transformer components are secured together;

FIGS. 23 and 24 show two alternative ways in which the transformer terminals can be brought to the same face of the completed transformer;

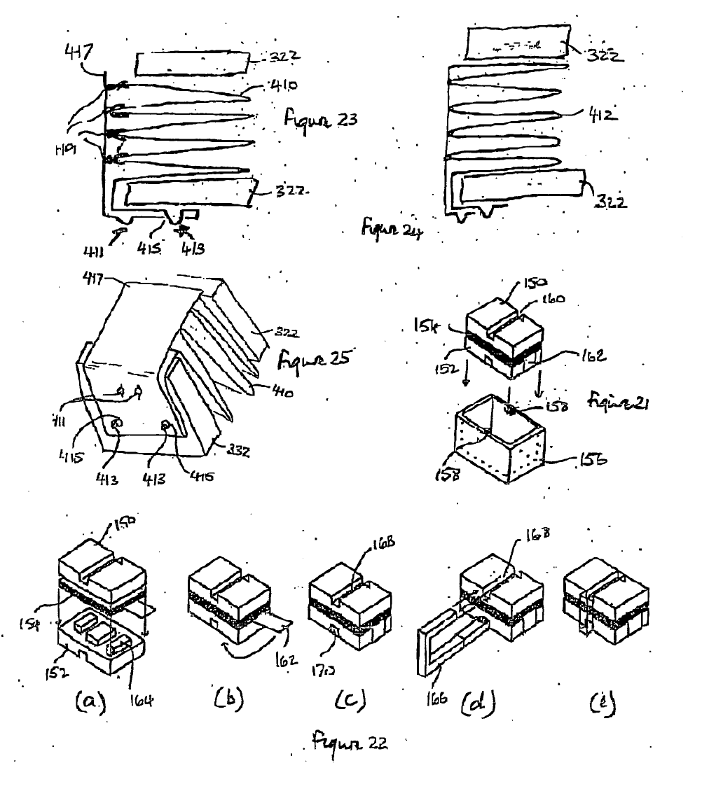

FIG. 25 is a perspective view of the transformer of FIG, 23;

FIG. 26 shows an outline of a flex strip;

FIG. 27 shows the arrangement of terminals on a ferrite body;

FIG. 28 is an exploded view of a transformer in accordance with the invention;

FIG. 29 shows the transformer of FIG. 28 assembled;

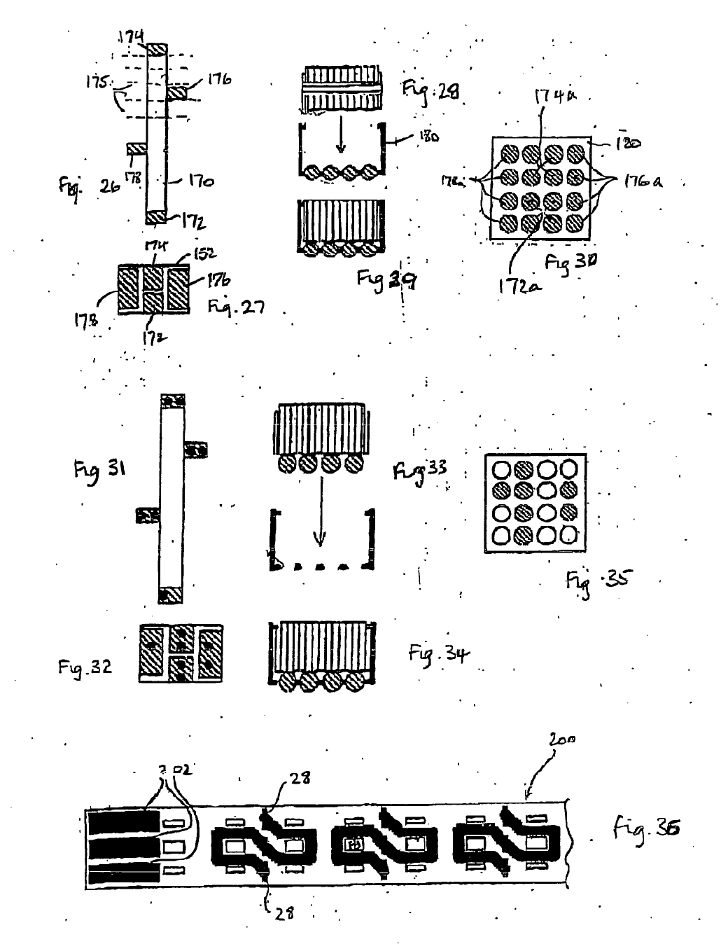

FIG. 30 is an underneath view both the transformer or FIGS. 28 and 29;

FIGS. 31 to 35 show views similar to those of FIGS. 26 to 30, but of an alternative embodiment;

FIG. 36 shows an alternative form or flex strip according to the invention;

FIGS. 37 and 38 show different interleaving arrangements for Z-folded transformers;

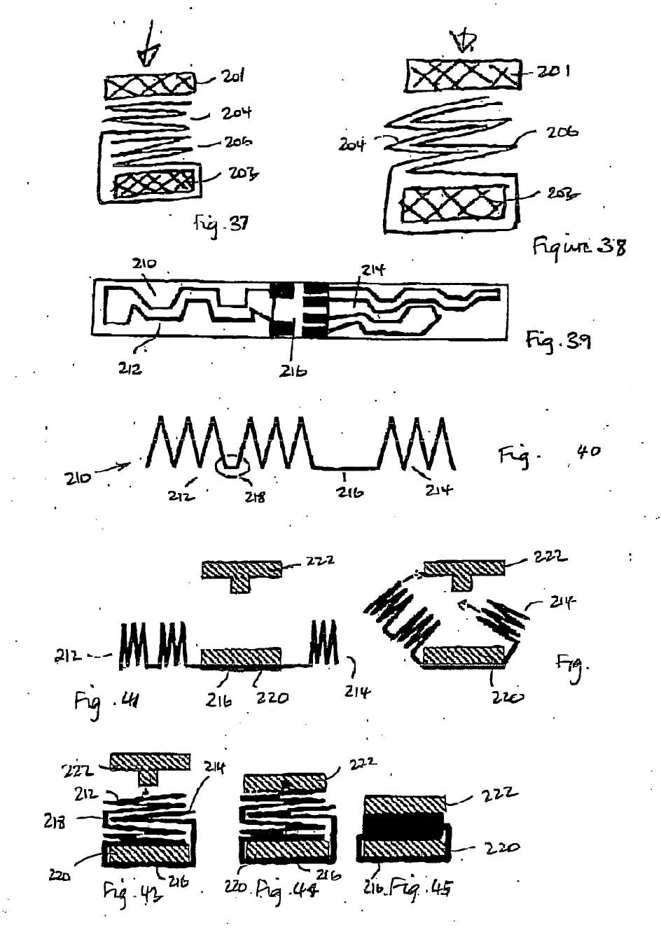

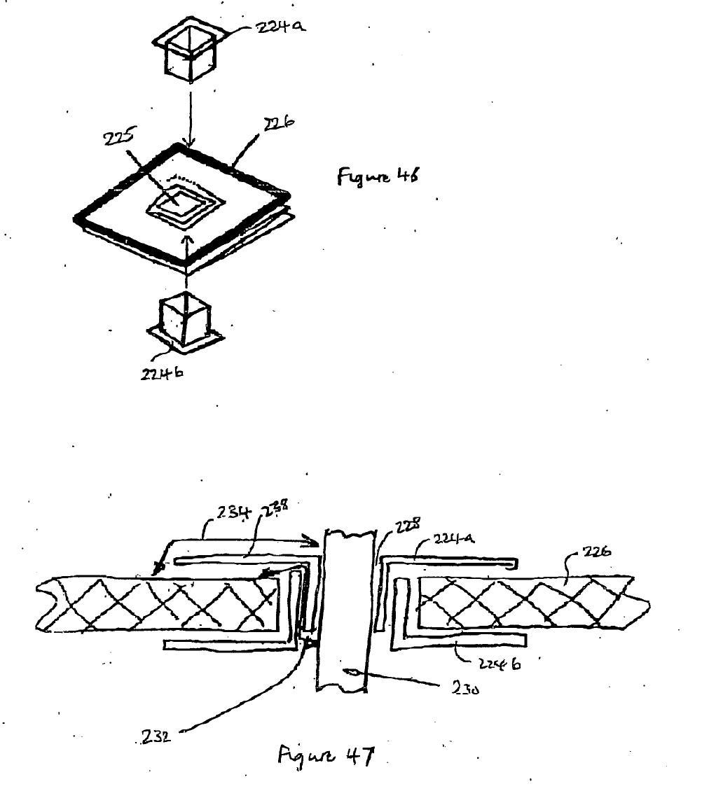

FIG. 39 shows a flex strip prior to folding;

FIG. 40 shows the strip of FIG. 39 after a first stage of folding;

FIGS. 41 to 45 show sequential stages in the assembly of a transformer from the strip of FIGS. 39 and 40;

FIG. 46 is a perspective, exploded view of a Z-folded transformer winding with a two-part bush for the ferrite core hole;

FIG. 47 shows a section through the assembled transformer winding of FIG. 36;

FIG. 48 shows a flex strip in accordance with the prior art;

FIGS. 49 and 50 show alternative flex strip layouts;

FIG. 51 is an exploded view of a transformer with a ferrite core and a strip as shown in FIG. 49 or 50;

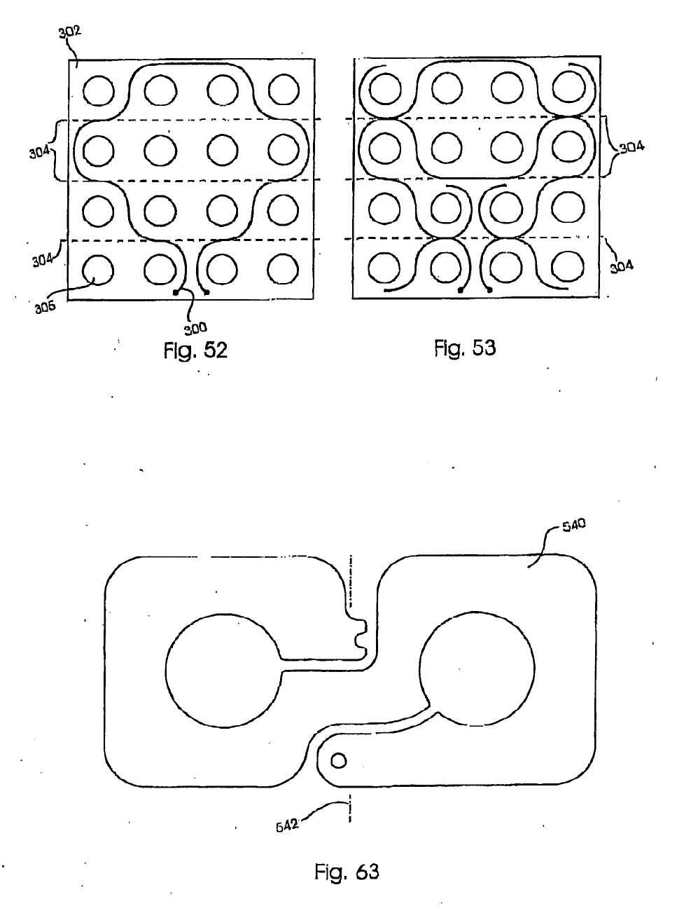

FIGS. 52 and 53 show two further alternative flex strip layouts;

FIG. 54 shows a side view of a flex strip support;

FIG. 55 and 56 show the support of FIGS. 54 after a flex strip has been mounted on the support;

FIGS. 57, 58 and 59 show details of the assembly of a transformer according to the invention;

FIGS. 60, 61 and 62 show details of the assembly of another transformer according to the invention;

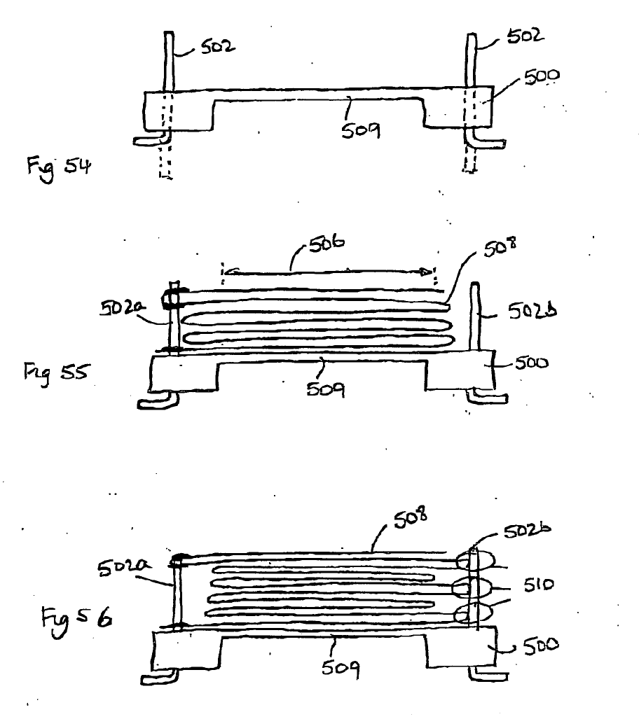

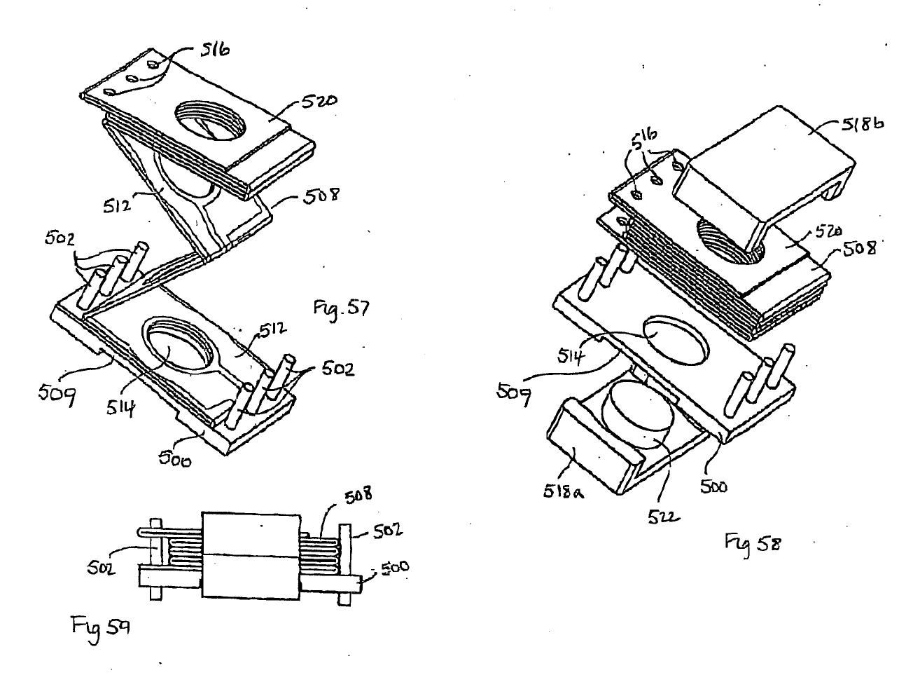

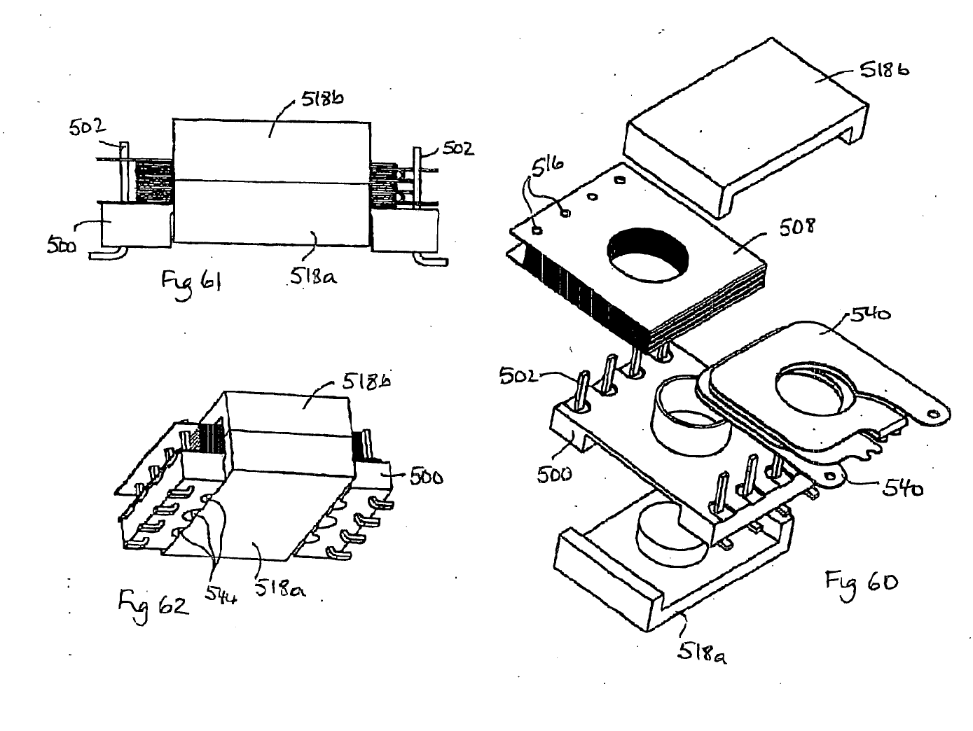

FIG. 63 shows and interleaving component, in the flat state;

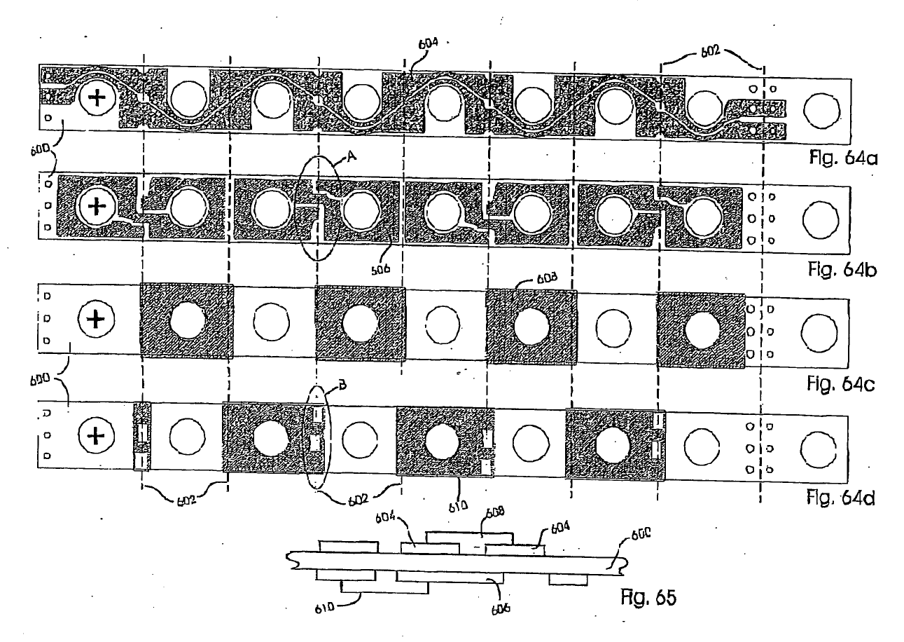

FIGS. 64a, 64b, 64c and 64d show respectively copper and resist layers applied to opposite sides of a substrate; and

FIG. 65 shows a typical cross section through the substrate of FIG. 64.

FIG. 1 shows a simple prepared substrate which comprises a Kapton sheet which has a rectangularly outline 10 (indicated by dotted lines). Initially, substantially the entire surface of each face of the sheet has a coating of electrically conductive copper applied to it. To prepare the sheet, the copper is selectively removed, for example by an etching process. The copper track left once the substrate has been prepared is indicated at 12. Fold lines in the substrate are indicated at 14 and holes through which a ferrite core will be positioned in the finished transformer (the holes will all register with one another once the substrate has been folded on itself) are shown at 16. It will be seen that (a) more than 50% of the initial copper coating has been removed to form the serpentine track 12, and that (b) the width of the track 12 is greater at the positions where it crosses the fold lines 14 tan it is between the fold lines.

This transformer component is also sometimes referred to as the ‘flex strip’.

FIG. 2 shows a flex strip, modified in accordance with the first aspect of the invention. It will be seen that additional areas of copper 12a are present on the strip 10 to almost completely encircle the core positions 16. In order to bring those areas 12a into the electrical circuit, at the positions marked X (see FIG. 3), conductive surfaces are exposed so that, when the flex strip is folded on itself, the two areas X marked A make electrical contact with one another and the two areas X marked B also make electrical contact with one another. As a result, the area of conductive copper forming the track is doubled.

FIG. 4 shows a cross section through a folded flex strip at one of these positions X. FIG. 4 shows only two leaves, but in practice there will be a much greater number overlying one another and forming a stack of leaves. The thickness of the copper layers 12 are very much exaggerated in the Figure, to explain the construction.

Each of the flex strip leaves 10 has a copper track 12 on each side. In the Figure, the copper tracks on the upper and lower side of each leaf are all coincident, but this does not have to be the case. The copper tracks 12 are protected by an insulating layer 10 which can be a layer of solder resist. At the point X, the solder resist is removed on both upper and lower tracks, and electrical conductive contact is made between the tracks. To achieve this contact, solder may be flowed over the areas where resist has been removed. The surface of the copper tracks may be electroplated with tin to ensure good contact between the solder and the copper.

In this way, a larger area of copper track is available to carry current around the ferrite core which will be fitted through the holes 16. This will improve the transformer capacity and will also mechanically stabilise the winding stack.

FIGS. 5a and 5b show two opposites sides of a flex strip. The strip is generally indicated at 30 and has hoes 32 through which the ferrite core will be passed. The continuous area indicated by reference numeral 34 is all copper coated, with the copper only being removed in the areas indicated by 36. Copper is also removed in the areas marked 38, as these areas are coincident with the desired fold lines and this will therefore assist in ensuring that the flex strip folds at the correct positions. After folding, electrical contact can be achieved in the appropriate areas of two facing surfaces of the leaves. One pair of facing surfaces has marks ‘X’ to show where contact can be made.

In the embodiment shown, it is necessary to add some insulation in the shaded areas 39, to prevent shorting out between the conductive tracks on outside folds.

In comparison with FIG. 2, the embodiment of FIGS. 5 has a much greater conductive area.

FIG. 6 shows how a single turn, centre tapped winding can have the turns connected in parallel using this method. The Figure shows a flex strip 20 which has holes 22 for receiving a ferrite core, fold lines 24 and printed copper tracks 26. The copper tracks are shown in the Figure with rectangular enlargements 28 at the ends and the middle of each track, where they cross the fold lines 24.

FIG. 7 shows the strip of FIG. 6 partly folded. No tracks are shown on the reverse side of the strip, but tracks can be and are likely to be provided there also. It will be seen from this figure that when the strip is folded, the holes 22 come to lie above on another so that a ferrite core can be inserted though them, and that the enlargements on the next adjacent fold line. By removing the insulating covering on the tracks at the fold lines, the tracks can be electrically connected to one another at these points. Thus all the tracks 26 (which in the flat state of FIG. 5 are independent of one another) are connected with each other in parallel, with the centre enlargement 28 forming a centre tap. The position on the fold lines where contact is made between adjacent turns does not have to be enlarged as shown; the width of the track could be uniform all along its length and the necessary contact could still be made.

It is also possible with this arrangement to make contact between adjacent tracks at some of the fold lines but not at others.

In another arrangement (FIG. 8) the same principle is used to connect windings in series. This arrangement has the advantage that a spiral track can be formed on each folded section of the substrate, thus allowing a greater number of ‘turns’ per ford in the finished transformer.

In FIG. 8, the flex strip 40 has holes 42 for the ferrite core and, on each leaf of the strip a spiral conductive track is formed. On the leaf 40a, the track 44 starts from a terminal 46 and ends at a point 48 on the leaf 40a. On the next track 40b, the spiral starts from the point 50 and then follows a spiral path outwards and then crosses onto the next leaf 40c where the track continues on a spiral path, now spiralling inwards to finish at a point 52. One the leaf 40d, the track extends from a point 54 to another terminal 56. At lease on of the facing faces of the strip will be coated with a resist, so that they do not short out between the coils on facing surfaces. However the resist will be removed at points 40, 50, 52, 54.

When this flex strip is folded up, about the fold lines indicated by dotted lines, contact will be made between the track on leaf 40a and the track on leaf 40b, because the pints 48 and 50 will come into contact with one another and will, in the manner shown in FIG. 4, be brought into electrical contact with one another. The same happens between the points 52 and 54 on the leaves 40c and 40d. Alternatively, contact may be achieved by ‘bumping’ the points 48 and 50 or 52 and 54 so that they extend slightly out of the plane of the strip, to come into contact with one another. This will assist in ensuring that the thickness of the resist does not prevent the desired contact.

In this way a single winding is effectively formed throughout the whole of the transformer, and it is now possible to place multiple turns on each of the strip, and then to connect the turns on one strip with the turns on another strip, so that all the turns are in series. This may be particularly useful for an inductor with many turns.

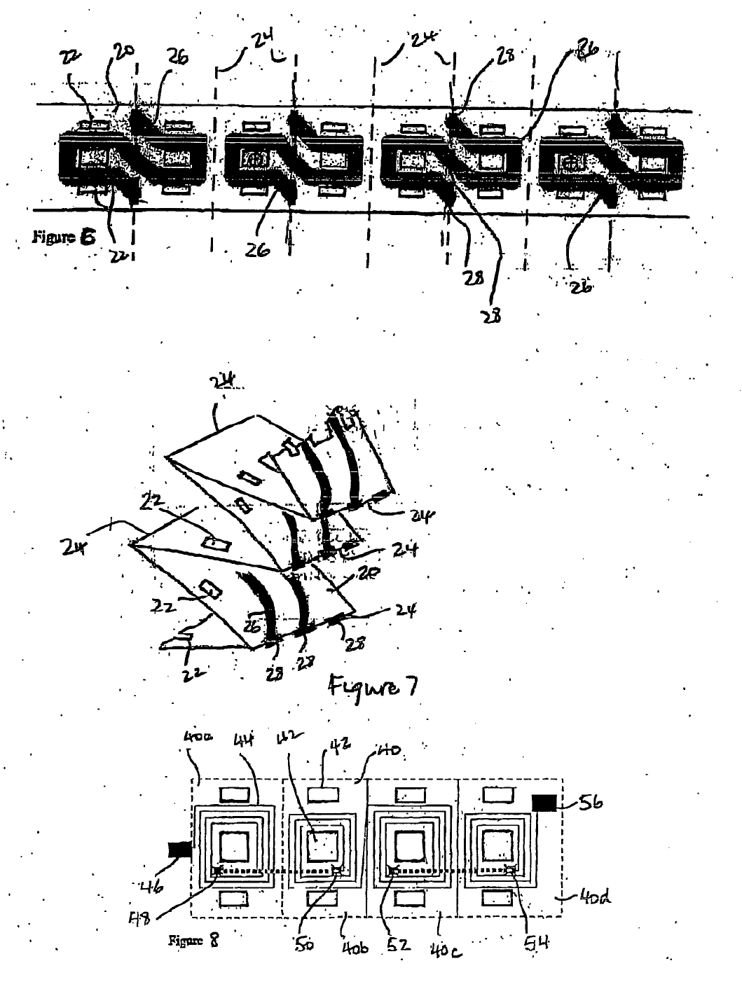

FIG. 9 shows an arrangement similar to that in FIG. 8, but this time there are two coils formed on the same flex strip 60. The track 62 forms half a turn on each leaf 60a, 60v to 60f. The track 64 forms two turns on the leaf 60a, one turn on the lead 60d, one turn on the leaf 60e and half a turn on the leaf 60f. Where there is more than half a turn on a leaf, then the turns are connected to the turns on the adjacent leaf by making electrical contact in the folded strip such as takes place between points 66 and 68, and between points 70 and 72.

In FIG. 10 an arrangement effectively the same as that in FIG. 8 is shown. However, in this case the tracks are spiral wound, and the connections are made between the points A-A and B-B.

In FIG. 11 a more complex mixture of track patterns is illustrated. One track 82 extends the full length of the flex strip, similar to the track 62 of FIG. 9. However, the coil 84 takes the form of a spiral on the leaf 80b, half a turn across the next leaf 80c and a spiral on the leaf 80d. When the flex strip is folded, there will be contact between the coil 84 where it appears on the leaf 80d and a coil 86 where it appears on the leaf 80c (B-B). Similarly there will be contact between the coil 84 where it appears on the leaf 80b, and another coil 85 on the leaf 80a (A-A). Thus the current path travels (always in the same rotational direction) spiralling in and out on different leaves and upwards and downwards between the leaves in the completed transformer.

It will be clear that the ability to form in this way a via between tracks on two adjacent surfaces allow a very wide variety of different turn patterns to be produced.

FIG. 12 shows one other embodiment of the invention. In this embodiment an additional area of copper is left on the flex strip at 90, 92. This area of copper takes no part in the electrical characteristics of the finished transformer (it is isolated from the current path), but instead these two areas 90, 92 are set up so that they can be soldered to one another in the finished strip to physically fix the leaves of the strip in their folded configuration.

Instead of the rectangular area shown in FIG. 12, it might for example be possible to leave a small area of copper at each corner of each leaf of a rectangular flex strip, with the copper at these areas being exposed so that they can be joined, for example soldered, to corresponding areas on the adjacent leaf in the manner shown in FIG. 4.

FIG. 13 shows a possible construction for a substrate to be used in a Z-folded transformer. The substrate is formed as a continuous web, with a polyester ‘core’ 100 provided on each side with a layer of copper 102,104 (which will form the tracks 12, 26) and along each edge, a ribbon 106 of a polyimide material such as Kapton. The completed laminate is indicated at 108.

Flex strips 10, 20 will be cut transversely from this web (see FIG. 15), such that they have polyimide 106 at the two ends of the strip (from which connections will be made to external circuit components) and low cost polyester for the major part of the structure. Polyester is considerably cheaper than polyimide and has better moisture absorption characteristics than polymide. However, polyester does not have the necessary heat resistance to allow external components to be soldered to tracks on the substrate, and the higher grade polyimide material is advantageous at points where soldering is to take place.

The polyimide films may have adhesive coatings to attach them to the polyester.

Another problem inherent in Z-folded transformers is that of completing the assembly as a rigid component which can be mounted for example on a circuit board, or to which other components can be attached.

In the following FIGS. 16 to 47, various constructions are shown in which a folded transformer substrate and associated ferrite cores are joined together to form a component which can be regarded as a single rigid unit and which can therefore be easily mounted on a circuit board in the same way as a conventional wirewound inductive component.

FIG. 16 shows a side view of an assembled transformer with a Z-folded flex strip 120 sandwiched between two ferrite bodies 122, 124. Although not shown in this Figure, the ferrite bodies will have projections which extend through holes in the flex strip 120, as previously described.

The ferrite bodes 122 and 124 are solid, rigid bodies. Two end terminal portions 126 and 128 of the conductor formed on the flex strip 120 are brought out from where the flex strip is folded on itself and exposed on the lower face of the body 124, as indicated at 126 and 128. By mounting these two end portions on the rigid surface of the body 124, terminal 126 and 128 are rigidly fixed in space. The terminals 126, 128 can be glued or otherwise fixed in place of the body 124, but in FIG. 17 an additional component in the form of a clip 130 is applied to the assembly. The clip 130 engages around both the ferrite bodies 122, 124a to hold the two bodies together and to hold the flex strip in its folded configuration between the bodies. Additionally the clip 130 retains ends 125a, 128a of the flex strip 120 so that these extremities of the strip are held captive. FIG. 18 shows this in end view, where the clip 130 has flanges 132 which engage over the top of the ferrite body 122, and a continuous limb 134 which extend beneath the body 124a.

In this embodiment the body 124a is shaped with bulbous projections from its lower surface around which the terminal ends (126a, 128a) of the flex strip are passed. The actual terminal of the transformer, for connection to other components, will be formed at the lowermost parts of these bulbous projections. FIG. 17 shows how the tree ends of those terminal portions 126a, 128a are trapped beneath a continuous lower limb 134 of the clip 130.

FIGS. 19 and 20 show another embodiment where a substantially continuous housing 140 is used in place of a clip 130. FIGS. 19 shows the housing before the transformer components have been mounted inside it, and FIG. 20 is a section through the housing with a transformer in place.

The housing has resilient lugs 142 near its top edge, end cut outs 144 and base slots 146. The transformer to be mounted within this housing is similar to that depicted in FIG. 16, and the same reference numerals will be used for its components.

The size of the housing 140 is such that when the transformer is completely inserted, the top surface of the upper ferrite body 122 will snap beneath the lugs 142, and thus the lugs will effectively keep the ferrite bodies pressed into the housing and will keep the flex strip 120 compressed between them.

The terminal ends 126, 128 of the flex strips pass out of the housing through the cut-outs 144 at each end, pass around the outer surface of the housing and then back into the housing through the slots 146. Once they are back inside the housing, the upper ferrite body can be finally snapped down to trap the free ends of the terminals 126, 128 between the lower ferrite body and the base 148 of the housing. It will be noted in this Figure that the bulbous shape present on the lower ferrite body 124a of FIG. 17 is in this case provided by shaping of the housing 140, rather than shaping of the lower ferrite body.

FIG. 21 shows a similarly arrangement where a transformer consisting of ferrite bodies 150, 152 and flex strip 154 is snap-fitted into a rectangular box 156. The box 156 has lugs 158, and when the transformer is correctly inserted, the lugs 158 will be accommodated within a slot 160 on the upper face of the upper ferrite body 150. The manner in which the terminal ends 162 of the flex strip are connected to external components is not illustrated in this Figure.

FIG. 22 shows a sequence of steps in the assembly of a transformer in accordance with the invention. In FIG. 22a, the three main components are shown in exploded view, namely the upper ferrite body 150, the Z-folded flex strip 154 and the lower ferrite body 152. In this Figure it can be seen that the lower ferrite body has core pieces 164 which extend up from the internal face of the body and which will extend through holes in the folded flex strip (e.g. the holes 22 in FIG. 7). These core pieces may extend right through the folded flex strip to meet a flat lower face of the upper body 150, or the upper body 150 may have similarly core pieces and the core pieces of upper and lower bodies may meet half way through the folded flex strip.

FIG. 22b shows the three components assembled together with a terminal end 162 of the flex strip 154 exposed. Although not shown in this Figure there will be a similar exposed terminal end at the opposite (hidden) end of the assembly. This terminal end is folded under the lower ferrite body 152 (FIG. 22c) in a manner similar to that shown in FIG. 16. In order to retain the assembly in this condition, a U-shaped clip 166 engages in corresponding grooves 168, 170 on the upper and lower faces of the bodies 150, 152. FIG. 22e shows the finished condition of the transformer.

FIGS. 23 and 24 show two alternative configurations in which both ends of the flex strip are brought out of the component on the same face, for connection to external terminals. In these figures, the ferrite bodes 322 are shown spaced apart, to enable the folding pattern of the flex strips 410, 412 to be displayed.

In FIG. 23, the points of the strip 410 to which connection will be made are in the form of ‘bumps’ 411, 413 pressed out from the plane of the strip. The bumps are initially pressed out in opposite directions, and then when the strip is folded, the bump 413 projects through a hole 415 in the strip, so that both the ‘bumps’ are projected in the same direction. Tracks at one edge of each leaf are in electrical contact (at 419) with tracks on an end region 417 of the strip 410.

In FIG. 24, a different folding pattern is shown for the strip 412. Here the ‘bumps’ are at opposite ends of the strip, but are presented adjacent one another after folding of the strip.

It will be clear that the pattern of tracks on the strip will be set up so that any desired conductive array can be produced, with the tracks, and their terminals, being arranged as desired across the width of each face of the strip.

FIG. 25 shows an underneath view of the component of FIG. 23.

FIG. 36 shows a modified flex strip 200. This strip 200 is similar to the strip 20 of FIG. 6, but has termination areas 202. When the strip 200 is folded, the areas 202 will make contact (as described with reference to FIG. 6) with the enlargements 23. Because the terminations areas 202 are relatively large and uniform in shape, they can present a large area to which external connections can be made.

FIGS. 26 to 30 and FIGS. 31 to 35 show two alternative arrangements whereby the terminal ends of a flex folded transformer (with centre taps) can be reliably and accurately connected to for example a printed circuit board.

FIG. 26 shows a flex strip 170 with termination areas indicated at 172 at both ends and at positions alongside each elongate edge of the strip. FIG. 26 shows the strip 170 before it is folded, with some of the lines along which it will be folded indicated at 175. FIG. 27 shows the underside of the lower ferrite core once the strip has been folded up and mounted between upper and lower ferrite bodies. It will be seen that the terminal portions 172, 174, 176, 187 are now presented, spaced apart from one another on the lower face of the body 152. Next, the assembled transformer is inserted into a housing 180 which has a ball grid array in the base, so that the terminals 172, 174, 176 and 178 make contact with respective ones of the balls. FIG. 30 shows the underside of the housing 100 with a 4×4 array of balls. For example the terminal 178 may be in contact with the four balls 172a, the terminal 172 may be in contact with the four balls 178a, the terminal 174 may be in contact with the four balls 174a and the terminal 176 may be in contact with the four balls 176a. Appropriate solder connections will be made within the housing between the terminals and the balls. Once the component is assembled, ie, in the condition indicated in FIG. 29, it can be accurately soldered to a circuit board by defining which of the balls in the array should be soldered to which connections on the circuit board.

FIG. 31 shows a similar arrangement but in this case the balls 190 are soldered to the terminals, and there are only balls present where there are connections to be made. This FIG. 35 shows an array similar to that of FIG. 30 but with only some of the ball sites populated. Final connections need to be made only between the populated ball sites and the appropriate connections on the circuit board.

When the flex strip is folded, it can be folded with or without interleaving. FIG. 37 shows a non-interleaved folding pattern with ferrite cores 201,203 where all of one set 204 of folded leaves are above all of the other set 206 of folded leaves. FIG. 3A shows a fully interleaved folding pattern, where a pair of folded leaves from one set 204 are interleaved between each pair of folded leaves from the other set 206. The ferrite cores are then pressed together to close up the Z-folded leaves.

FIG. 39 shows a flex strip 201 which can be folded to from a transformer. The strip has primary winding sections 212 at one end of the strip and secondary winding sections 214 at the other end of the strip. The PCB terminations 216 are located at the middle section. The winding patterns are designed so that the windings start and end at the termination area 216.

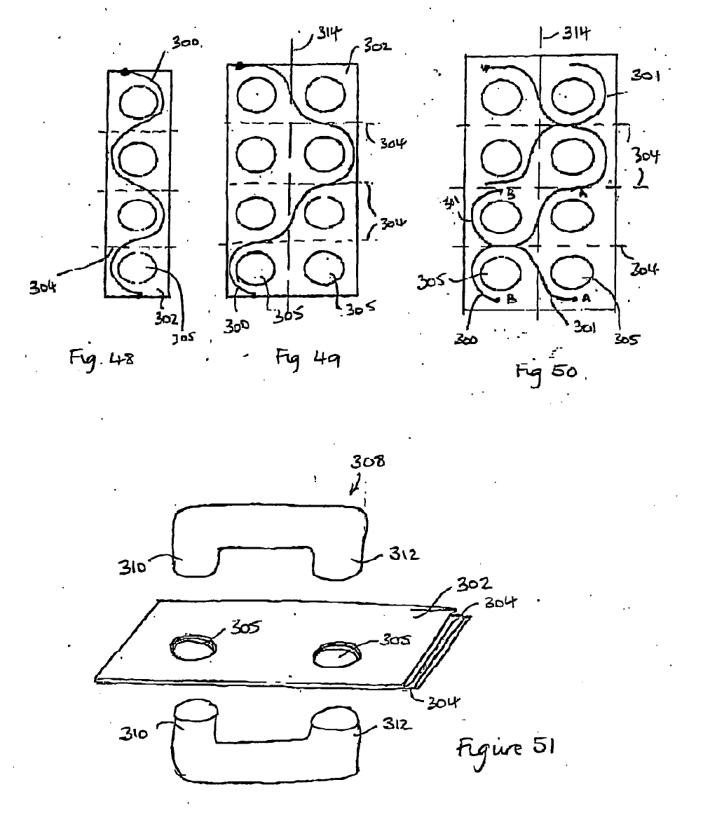

The flex 210 is Z-folded as shown in FIG. 40. The primary section has a region 218 where leaves are spaced apart and into which the secondary winding stack will be later interleaved. FIGS. 41 to 45 show the assembly of this strip into a transformer. In FIG. 41, the termination area 216 is placed against (under) a ferrite bottom plate 220. The winding sections 212,214 are flipped above the ferrite bottom plate. (FIG. 42) and interleaved with each other (FIG. 43). A ferrite top plate 222 is attached with glue, clips or similar (FIG. 45).

One attractive benefit of this construction is that there are no ‘ends’ to glue or lock. The ferrite itself, when the two halves are fixed in place, holds the assembly fully captive with the free ends of the flex strip effectively trapped. The location of the termination parts 216 beneath the ferrite bottom plate 220 makes it easy to attach the components to other connections, for example on a PCB.

Interleaving of primary and secondary windings can be designed more flexibly than with conventional Z-folded transformers where primary and secondary layers follow each other (complete interleaving) and interwinding capacitance may become excessive. In forward converters two to three times interleaving may be the best choice as a comprise between leakage inductance and interwinding capacitance.

A single sided flex strip can be used. Static shields can be placed on the opposite side using a thin copper layer.

FIG. 46 shows Z-folded secondary transformer windings 226 together with a two-part bushing or bobbin 224a, 224b. The two halved of this busing fit into a hole 225, from above and below, and clip together to form a lining to the hole 225, and to provide a hole 228 through which a ferrite core 230 can be inserted. The bushing 224 builds extended creepage paths 232, 234 (for example these paths may be 6 mm long) between primary and secondary windings.

The use of the bushing 224 enables certain minimum creepages and clearances to be met. Assume the tracks of the primary winding are close to the ferrite centre pole. Then a minimum creepage distance must be maintained from the centre pole to the secondary winding, and this can easily be achieved along the labyrinthine passage 232 illustrated in FIG. 47, and over the flanges 238 of the bushing, as shown at 234. The bushing will preferably be made of two plastics moulded parts.

Alternative winding patterns for Z-folded transformers in accordance with the invention are shown in FIGS. 49, 50, 52 and 53. With the winding layouts shown here no solder resist, lamination or the insulation is required on the flex strip after arrangement of the tracks and prior to Z-folding.

FIG. 48 shows a conventional winding pattern with a track 300 on a flex strip 302 with holes 305 for a ferrite core, and fold lines 304. An insulation layer (solder resist, paint, epoxy, tape etc.) is needed to prevent the conductor tracks 300 from short circuiting between each other when the strip is folded.

FIG. 49 shows an alternative conductor pattern on a flex strip 302 with two rows of core holes 305. This strip can be Z-folded on the fold lines 304 without any copper conductors being shorted together because the winding turns are completed on Z-folded sections 306 which are separated by the insulating substrate. Folding on the three fold lines 304 produces a concertina with two holes for ferrite cores but no shorted tracks. It is envisaged that this would fit with a two-part ferrite 308 with two centre poles 310, 312, as shown in FIG. 51.

When folded, the tracks always go clockwise round one pole and anti-clockwise around the other, so that the magnetic circuit is complete. For example, the flux direction can be downwards on one limb and upwards on the other, thus allowing the flus to circuit.

The strip of FIG. 50 has a basic conductor pattern which corresponds to that of FIG. 49, but which has added to it additional copper conductor areas 301 as described with reference to FIGS. 2 and 3 of this specification. When the strip is folded about the lines 304, there will be contact between points on the track, such as the points A-A and B-B, as described in connection with FIG. 3. The extra conductor parts 301 will contact the original conductor track 301 to increase copper thickness.

FIGS. 52 and 53 show conductor patterns with four core holes 305 on each leaf. The arrangement of FIG. 52 will, when folded, produce four turns around the cores in the holes 305. The arrangement of FIG. 53 applies the principles of FIG. 50 to the strip of FIG. 52.

It is also possible to make on or more longitudinal folds after the transverse folding, so, for example, FIGS. 49 and 50 would have three transverse folds 304 and a final longitudinal fold 314. This would leave one single central hole in the stack for a conventional centre pole. The advantage of this is that no insulation is required on the top of the copper to prevent shorting of tracks. The strips of FIG. 52 and 53 could also be folded longitudinally. It is quite possible also to do the longitudinal folding first, then the transverse folding, though, in these cases, the extra copper segments 301 in FIGS. 50 and 53 would need to be in different places.

Using the winding patterns of FIGS. 49-50 or 52-53 allows the use of a substrate with no additional insulation which is easier to manufacture and has a lower cost.

FIGS. 54 to 57 are schematic illustrations of different types of termination which will enable Z-folded transformers to be mounted on a circuit board using conventional mounting technology.

FIG. 54 shows a header 500, typically moulded from an insulating plastics material, with terminal pins 502 standing up from the header. The pins 502 extend beneath the header in a configuration which either is designed for surface mounting technology (full lines) or for through-hole mounting technology (dotted lines). The header is necessarily of insulating material, and is present to ensure that the finished, Z-folded component has a rigid structure.

FIG. 55 shows a Z-folded strip 508 mounted on the header, and with electrical terminations between conductive tracks on the strip and the terminal pin 502b, at 504. The strip 508 can have holes which can be placed over the pins 502. Some of the holes may be conductive tracks surrounding them, so that electrical connection can be made between the strip and the tracks, for example by soldering. Other holes may just provide a physical location to ensure that the strip is correctly positioned on the header. To complete the component, a ferrite body has to be mounted, and this will extend over the part of the flex strip indicated by the double-headed arrow 506. This length corresponds to the reduced thickness area 509 of the header. In order to minimise the height of the finished component above the circuit board on which it is to be mounted, the ferrite fits partly underneath the header, and the header should be as thin as possible at this point, consistent with providing the necessary insulation.

It is also possible (FIG. 56), to make electrical connections between tracks on the strip and the terminal pins 502 by butting parts of the strips against the pins and then applying solder to make the connection. This is shown at 510.

FIG. 57 shows a transformer with features as shown in FIGS. 54 to 56, partly assembled. The conductive tracks 512, a centre hole 514 for a ferrite core and holes 516 for fitting over the pins 502 can all be seen in this Figure. The strip 508 is Z-folded to form the compact package shown in FIG. 58, and this package is fitted to the header with the holes 516 fitting over the pins 502. A two-part ferrite core 518a, 518b with a central core 522 is then applied to the assembly with the core 522 passing through the hole 514, to form a finished product as shown in FIG. 59. The two halves of the core can be held together, for example by gluing.

The upper leaf 520 of the strip shown in FIGS. 57 to 59 has no conductive tracks. This leaf is folded over on top of the stack, and forms an insulating layer between tracks on the leaf below, and the surface of the ferrite.

FIGS. 60 to 62 show a similarly construction, but this time the Z-folded strip is interleaved with other, conducting, leaves 540. These leaves 540 are stamped from copper sheet and initially have the form shown in FIG. 63. They are folded about a fold line 542, before being interleaved with the flex strip 508. The leaves 540 will make electrical contact with the posts 502, as can be seen in particular with FIG. 6. Using interleaved conductors in this way expands the range of possible ‘winding’ and tapping configurations which can be achieved.

FIG. 62 shows an underneath view of this finished component, with the pins 502 set in positions appropriate for surface mounting the component on a circuit board. This figure also shows recesses 544 in the header 500, adjacent the position where the ferrite body 518a will fit. As a final step in production, these recesses will be filled with a settable compound, such as an epoxy resin, to firmly unite the header 500 with the ferrite body 518a, to impart rigidity.

FIG. 65 shows four views of the same flex strip 600, before folding. The fold lines are indicated at 602. FIG. 65a shows the pattern for copper conductors 604 on the top face. FIG. 65b shows the pattern of copper conductors 606 on the bottom face. FIG. 65c shows the pattern of resist 608 to be applied over the copper on the top face, and FIG. 65d shows the pattern of resist 610 to be applied over the copper on the bottom face. FIG. 66 shows an exemplary section through the strip and illustrates the relative positions of the layers.

It will be noted that the fold lines in some cases cross copper areas of the copper tracks, and in some cases cross non-copper areas. Where the fold lines cross copper areas, the copper track will be exposed at the edge of the fold, so that electrical connections can be made at that point. For this purpose, the resist is removed where such connections are to be made, and this can be seen for example by comparing the region circled at A in FIG. 65b with the region circled B in FIG. 65d. The resist coating is interrupted in areas where it is not required, so as to avoid unnecessarily increasing the thickness of the folded strip.

1-24. (canceled)

25. An inductive component comprising
an insulating substrate having opposing faces,
the substrate being folded into a plurality of connected, overlapping leaves,
each leaf having an aperture through which a magnetic core can be inserted to form the inductive component, wherein
conductive tracks are laid down on at least one face of the substrate,
each track includes external connection locations at which external connections can be made to the tracks,
the conductive tracks occupy substantially the whole of each leaf between the connection locations and
parts of the tracks have exposed conductive surfaces, which parts are in electrically conductive contact with other exposed conductive surfaces on adjacent leaves.

26. A component as claimed in claim 25, wherein the electrically conductive contact between tracks on adjacent leaves connects the tracks on the leaves in series.

27. An inductive component as claimed in claim 25, wherein the electrically conductive contact between tracks on adjacent leaves connects the tracks on the leaves in parallel.

28. An inductive component as claimed in claim 25, wherein a conductive track on at least one of the facing surfaces of adjacent leaves is provided with insulation to prevent electrical contact between tracks on the facing surfaces.

29. An inductive component as claimed in claim 25, wherein each track extends across a pair of adjacent leaves.

30. An inductive component as claimed in claim 25, wherein each track extends across all the leaves.

31. An inductive component as claimed in claim 25, wherein the contacts between adjacent leaves are located at the edges of the leaves.

32. An inductive component as claimed in claim 25, wherein there is more than one contact between any particular pair of adjacent leaves.

33. An inductive component as claimed in claim 25, which has terminals for making electrical connections to other components arranged on one and the same face of the component.

34. An inductive component as claimed in claim 25, wherein the substrate has conductive tracks on both faces.

35. A Z-folded transformer comprising an insulating substrate with conductive tracks laid down on at least one face of the substrate, wherein the substrate is folded into a plurality of connected, overlapping leaves, and a ferrite core inserted through an aperture in each leaf, wherein on every leaf of said at least one substrate face, a conductive track extends around the ferrite core and wherein parts of the tracks have exposed conductive surfaces, which parts are in electrically conductive contact with other exposed conductive surfaces on adjacent leaves, and wherein each conductive track occupies substantially the whole of each leaf.

36. A transformer as claimed in claim 35, wherein the substrate has conductive tracks on both faces, and the tracks on one face form the transformer primary and on the other face form the transformer secondary.

37. A transformer as claimed in claim 35, wherein the folded substrate is secured in its folded state by a ferrite body which encircles the substrate to clamp the folds together.

38. A transformer as claimed in claim 35, wherein center taps are taken off from a conductive track, between the ends thereof.

39. A transformer as claimed in claim 35, wherein the insulating substrate has a plurality of separate conductive tracks laid down on the substrate, the substrate is folded into a plurality of connected, overlapping leaves with leaves carrying one conductive track interleaved with leaves carrying another conductive track.
